(19) United States
(12) Patent Application Publication
(10) Pub. No.: US 2017/0248992 A1
(43) Pub. Date: Aug. 31, 2017

(54) SYSTEMS AND APPARATUS FOR HOUSING ELECTRONIC COMPONENTS AND METHODS THEREOF

(71) Applicant: Microsoft Technology Licensing, LLC, Redmond, WA (US)

(72) Inventors: Kurt Jenkins, Sammamish, WA (US); Anthony Reed, Redmond, WA (US); Neil O'Connell, Seattle, WA (US); James Alec Ishihara, Bellevue, WA (US)

(21) Appl. No.: 15/053,934

(22) Filed: Feb. 25, 2016

(51) Int. Cl. G06F 1/16

(52) U.S. Cl. CPC G06F 1/1656; G06F 1/1637; G06F 1/1662

(57) ABSTRACT

A structure for housing electronic components. The structure includes a first layer and a second layer. One or more layers may each have a modulus of elasticity of less than 2.41 MPa. One or more layers may be at least partially affixed to form a combined layer. The combined layer may have a combined modulus of elasticity of less than 2300 MPa. The combined layer may be transparent to electromagnetic waves. The combined layer may be not electrically conductive across an entire surface area of the combined layer. The combined layer may be polycarbonate free. An outermost layer may be a textile layer.

### BACKGROUND

### Background and Relevant Art

Electronic components are typically sensitive to sources of damage such as direct impacts and fluids. Housings may be used to protect electronic components from damages. Many housings are injection molded or machined from a stock material. Injection molded or machined housings may require finishing, such as painting or anodizing.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In one embodiment, a structure for housing electronic components is described. The structure may include a first layer having a modulus of elasticity of less than 2.41 MPa and a second layer having a modulus of elasticity of less than 2.41 MPa. The second layer may be affixed to the first layer to form a combined layer. The combined layer may have a combined modulus of elasticity of less than 2300 MPa.

In one embodiment, a structure for housing electronic components is described. The structure may include an innermost textile layer and an outermost textile layer. The innermost layer may be bonded to the outermost layer to form a combined layer. The combined layer may be transparent to electromagnetic waves having a frequency between 600 MHz and 6 GHz or may not be electrically conductive across an entire surface area of the combined layer.

In one embodiment, a structure for housing electronic components is described. The structure includes a first layer having a modulus of less than 2.41 MPa and a second layer having a modulus of less than 2.41 MPa. The second layer may be affixed to the first layer to form a combined layer. The combined layer may be polycarbonate free.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a conceptual drawing of an embodiment of a mobile device;

FIG. 1-1 is a partial cross-sectional side view of the structure of FIG. 1 along line 1-1;

FIG. 1-1-1 is a partial cross-sectional side view along line 1-1 of FIG. 1 of another embodiment of a structure for housing electronic components;

FIG. 1-1-2 is a partial cross-sectional side view along line 1-1 of FIG. 1 of yet another embodiment of a structure for housing electronic components;

FIG. 1-1-3 is a partial cross-sectional side view along line 1-1 of FIG. 1 of a further embodiment of a structure for housing electronic components;

FIG. 1-1-4 is a partial cross-sectional side view along line 1-1 of FIG. 1 of a yet further embodiment of a structure for housing electronic components;

FIG. 2 is a conceptual drawing of an embodiment of a video game controller;

FIG. 2-1 is a partial cross sectional side view along line 2-1 in FIG. 2 of the structure of the video game controller of FIG. 2;

FIG. 3 is a conceptual drawing of an embodiment of a computing device;

FIG. 3-1 is a perspective isometric view of the structure of the monitor without the display;

FIG. 3-1-1 is a partial cross-sectional side view at 3-1-1 along line 3-1 in FIG. 3-1 of an embodiment of a structure of the monitor;

FIG. 3-2-1 is a partial cross-sectional side view at 3-2-1 along line 3-1 in FIG. 3-1 of the embodiment of the structure of the monitor in FIG. 3-1-1;

FIG. 3-1-2 is a partial cross-sectional side view at 3-1-1 along line 3-1 in FIG. 3-1 of another embodiment of a structure of the monitor;

FIG. 3-2-2 is a partial cross-sectional side view at 3-2-1 along line 3-1 in FIG. 3-1 of the another embodiment of the structure of the monitor in FIG. 3-1-2;

FIG. 4 is a perspective, isometric view of an embodiment of a structure for housing electronic components;

FIG. 4-1 is a partial cross-sectional side view of the structure of FIG. 4 along line 4-1;

FIG. 4-2 is a partial cross-sectional side view of the structure of FIG. 4 along line 4-2;

FIG. 4-3 is a partial cross-sectional side view of the structure of FIG. 4 along line 4-3;

FIG. 4-4 is a partial cross-sectional side view of the structure of FIG. 4 along line 4-4;

FIG. 5 is a perspective view of an embodiment of a structure with two portions for housing electronic components; and

FIG. 5-1 is a side cross-sectional view along line 5-1 in FIG. 5 of the embodiment of a computing device in FIG. 5.

### DETAILED DESCRIPTION

At least one embodiment disclosed herein includes a structure formed of layers that are bonded together, formed, and shaped in one step. At least one embodiment disclosed herein includes a structure that is composed of two or more layers that are weak (e.g., lack column and/or bending strength) alone, but when affixed (e.g., permanently connected) together have sufficient strength to house one or more components. Layers may be affixed by adhesive bonding, laser welding, ultrasonic welding, friction welding, overmolding, diffusion bonding, stitching, sewing, folding, injection molding other methods of affixing, or combinations thereof. At least one embodiment disclosed herein includes a structure that is composed of two or more layers that are weak individually, but when affixed together have a combined modulus of elasticity that is greater than 45 GPa while having a composite density that is less than 1740 kg/m³.

In some embodiments, a structure includes a first layer with a second layer attached to the first layer, where the first layer and the second layer form a combined layer. In some embodiments, the first layer and the second layer each have a modulus of elasticity of less than 2.41 MPa. The combined layer may have a combined modulus of elasticity of less than 2300 MPa.

The combined layer may be polycarbonate free. At least one embodiment of a structure described herein may include one or more layers of a non-woven or woven textile. The textile materials may include polyurethane, polyester, nylon, other materials, or combinations thereof, and/or may include weaves, knits, 3D knits, other layering patterns, or combinations thereof. The textile materials may exclude glass fibers.

The material of the outermost layer may be selected for cosmetic appearances. For example, a cloth outermost layer may not require paint or finishing (e.g., machining, polishing, or buffing). Example materials that may be used for the outermost layer may include textiles as described herein, leather, plastics, or combinations thereof.

At least one embodiment of a structure described herein may include an inner layer (e.g., third layer 130-3, input sensor 180-4) between an outermost layer and an innermost layer. The inner layer may include solid materials, non-solid materials, or combinations thereof. For example, the inner layer may include solid materials such as foam, plastic, cloth, additively manufactured metals and/or plastics, other solid materials, or combinations thereof. Non-solid materials may include gasses such as atmospheric air, helium, other non-solid materials, or combinations thereof.

In some embodiments, the structure includes an innermost fabric layer and an outermost fabric layer bonded to the innermost layer to form a combined layer. The combined layer may be transparent to electromagnetic waves having a frequency from 600 MHz to 6 GHz and any value therebetween or may not be electrically conductive. For example, the structure may not be electrically conductive across an entire surface area of the combined layer.

At least one embodiment of a structure described herein may have a maximum thickness through one or more layers of less than 1.5 mm, 1 mm, 0.8 mm, 0.7 mm, or any values therebetween. At least one embodiment of a structure described herein may have composite density of less than 1740 kg/m³.

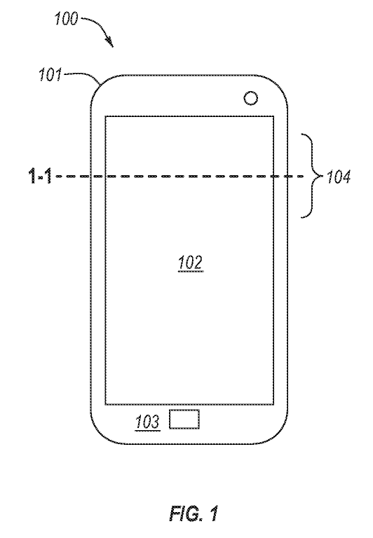

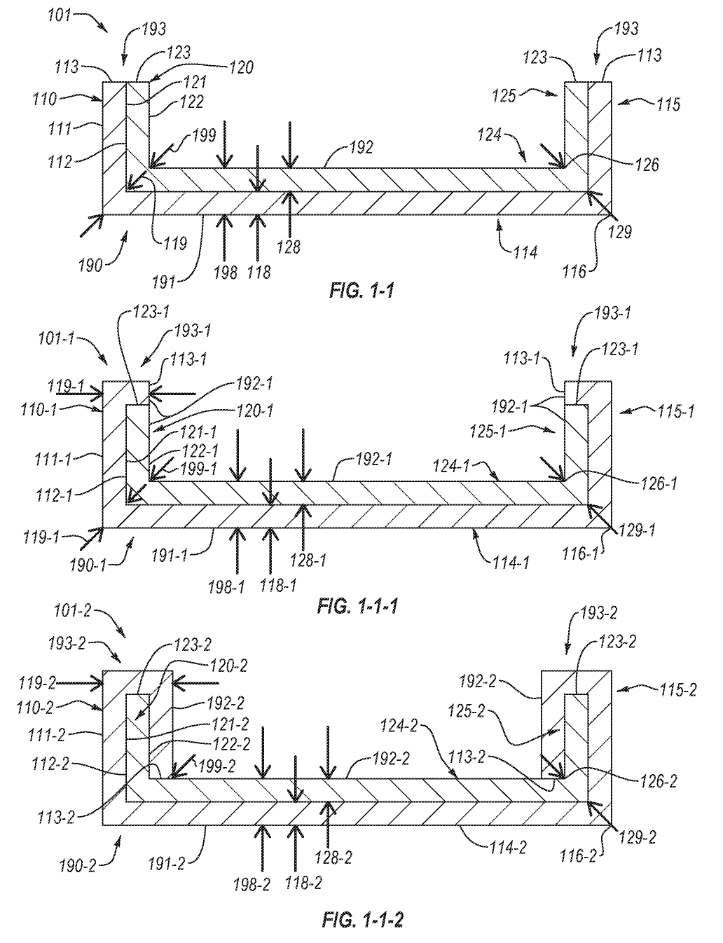

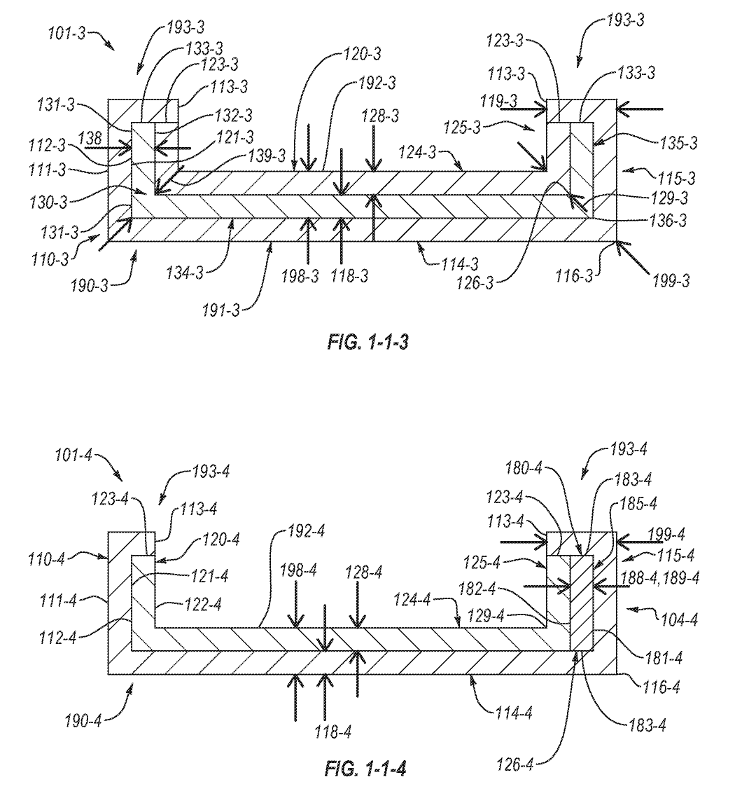

Referring now to FIG. 1, a conceptual drawing of an embodiment of a mobile device 100 is shown. The mobile device 100 (e.g., a smart phone and/or tablet) includes a structure 101 for housing various electronic components. For example, the structure 101 may house a processor, memory, a battery, one or more sensors, a transceiver, other internal components, or combinations thereof may be associated with the mobile device 100.

The mobile device 100 may include a display 102. The display 102 may display various pieces of information to a user via, for example, a graphical user interface.

The mobile device 100 may include an input 103. The input 103 may communicate with the mobile device 100 to control what is displayed on the display 102. For example, the input 103 may be a start button (e.g., a start button on a smart phone and/or tablet). In some embodiments, the display 102 may act as an input. For example, the display 102 may include touch sensors that facilitate user input with the mobile device 100. In some embodiments, the structure 101 may act as an input. For example, the structure 101 may include a capacitive touch area 104.

FIGS. 1-1 through 1-1-4 are partial cross-sectional side views along line 1-1 in FIG. 1 of various embodiments of structures for housing electronic components. FIG. 1-1 is a partial cross-sectional side view along line 1-1 in FIG. 1 of the structure 101 of the mobile device 100. The structure 101 includes a first layer 110 and a second layer 120.

The first layer 110 and the second layer 120 include outermost surfaces 111, 121 and innermost surfaces 112, 122, respectively. Innermost surfaces include surfaces that may be adjacent to electronic components (or structures associated therewith). Outermost surfaces include surfaces with which a user may come into contact during use of a device (e.g., mobile device 100). Although terms like innermost and outermost are used to describe orientation and/or location, they are merely used to orient the reader. Other terms like topmost, bottommost, etc. could be used in addition to in the alternative. The surfaces described herein may define surface areas.

The first layer 110 and the second layer 120 may be at least partially affixed together. For example, at least a portion of the innermost surface 112 of the first layer 110 may be affixed to at least a portion of the outermost surface 121 of the second layer 120.

The first layer 110 and the second layer 120 may include one or more peripheral edges and/or surfaces 113, 123, respectively. As shown in FIG. 1-1, the peripheral edges 113, 123 may be coterminous (e.g., end at the same point). In some embodiments, only two of the peripheral edges 113, 123 may be coterminous while two other peripheral edges 113, 123 may not be coterminous. In further embodiments, none of the peripheral edges 113, 123 may be coterminous.

As shown in FIG. 1-1, the first layer 110 and/or second layer 120 may include one or more horizontal planar portions 114, 124 and/or one or more vertical planar portions 115, 125, respectively. The planar portions 114, 115, 124, 125 may be joined at edges 116, 126. In other embodiments, the horizontal planar portions 114, 124 and/or the vertical planar portions 115, 125 may be oriented at an angle to the horizontal or vertical, respectively. In further embodiments, a structure may not include any planar surfaces. Although the edges 116, 126 appear to be corners, in other embodiments, the edges 116, 126 may be rounded or otherwise shaped.

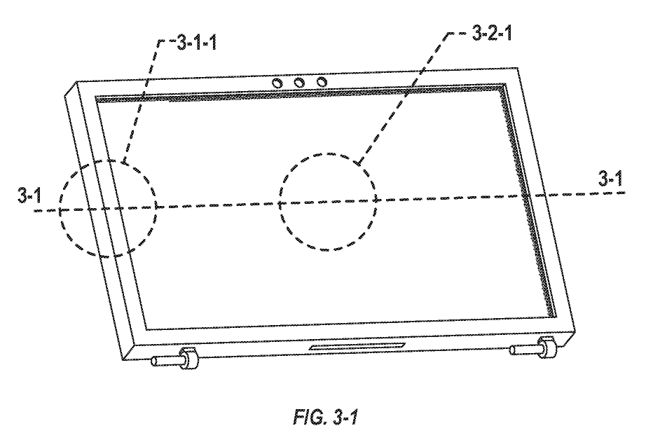

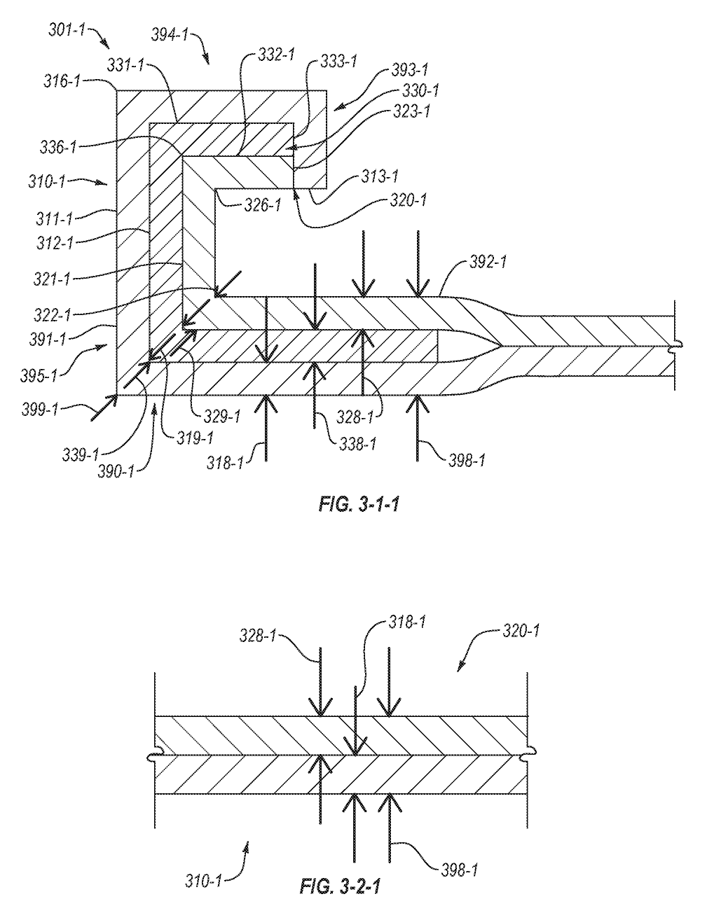

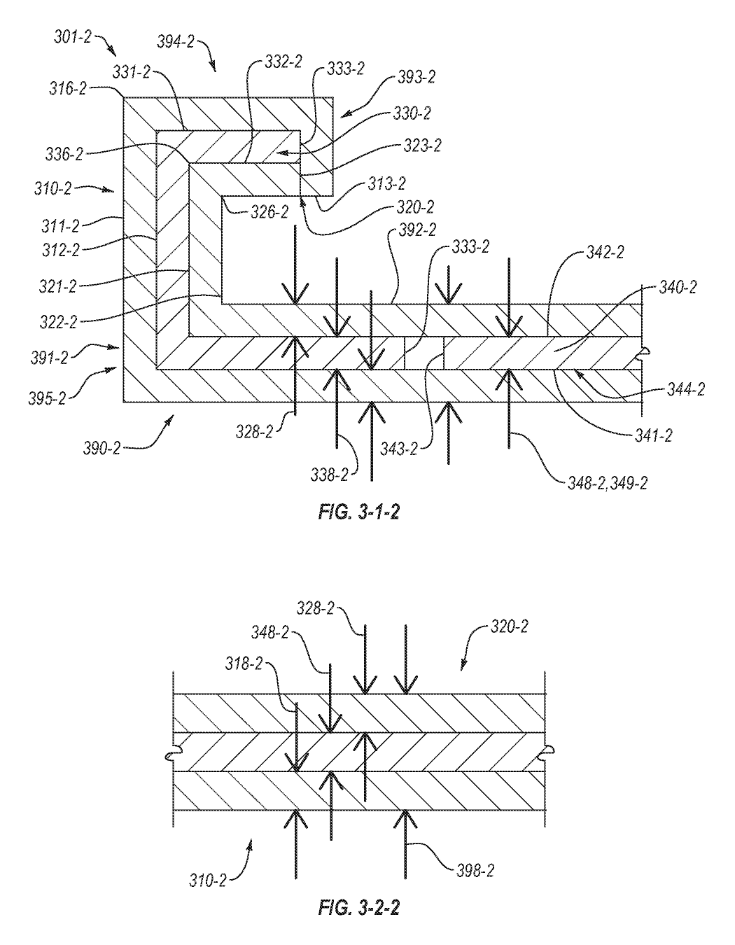

The innermost surface 122 of the second layer 120 may abut and/or be affixed to at least a portion of the display 102 of the mobile device 100. For example, at least a portion of one or more of the vertical planar portions 125 may abut at least a portion of the display 102. In another example, at least a portion of one or more of the combined layers may overlap at least a portion of the display 102 (e.g., to hide any border around the display 102). At least one embodiment of a structure for housing electronic components described herein may reduce a gap (e.g., display gap 306 shown in FIG. 3) between an edge of the display (e.g., display 102) and the structure 101. For example, the innermost surface 122 of the second layer 120 may be adjacent (e.g., with no other intervening surfaces) to the display 102. In some embodiments, the gap may range from about 0.05 mm to about 2 mm and any value therebetween.

The first layer 110 and the second layer 120 may each have a thickness 118, 128, respectively. As shown in FIG. 1-1, the thickness 118 of the first layer 110 and/or the thickness 128 of the second layer 120 may be uniform (e.g., approximately the same) along one or more of the planar portions 114, 115 of the first layer 110 and/or the planar portions 124, 125 of the second layer 120. In other embodiments, the thicknesses 118, 128 of the first layer 110 and/or second layer 120 may vary along one or more of the planar portions 114, 115, 124, 125.

The first layer 110 and second layer 120 may include maximum thicknesses 119, 129, respectively. As shown in FIG. 1-1, the maximum thicknesses 119, 129 of the present embodiment may be located at the edges 116, 126 of the first and second layers 110, 120. In other embodiments, the maximum thicknesses 119, 129 may be found at other portions of the first and/or second layers 110, 120.

The first layer 110 and the second layer 120 may define a combined layer 190. The combined layer 190 may include an outermost surface 191, an innermost surface 192, and one or more peripheral edges 193. As shown in FIG. 1-1, the outermost surface 111 of the first layer 110 is the outermost surface 191 of the combined layer 190, the innermost surface 122 of the second layer 120 is the innermost surface 192 of the combined layer 190, and both of the peripheral edges 113, 123 of the first and second layers 110, 120 define the peripheral edges 193 of the combined layer 190. In other embodiments, other portions of surfaces and/or portions of peripheral edges may be the outermost surface 191, the innermost surface 192, one or more of the peripheral edges 193, or combinations thereof.

The first layer 110 and second layer 120 may be formed of the various materials described above. For example, the first layer 110 may be formed of a textile material and the second layer 120 may be formed of a plastic and/or metallic material. In one example, the moduli of elasticity of the first and second layers 110, 120 may each be less than 2.41 MPa individually, but when affixed as described above, the combined layer 190 may have a modulus of elasticity that is less than 2300 MPa, more than 25 GPa, 45 GPa, or any values therebetween. In another example, the first and second layers 110, 120 may both be textile layers.

The combined layer 190 may include a combined thickness 198. The thickness 198 may be measured from the outermost surface 191 of the combined layer 190 to the innermost surface 192 of the combined layer 190. The thickness 198 may be uniform along one or more of the planar portions 114, 115, 124, 125 of the first and second layers 110, 120 whether the thicknesses 118, 128 of the first and second layers 110, 120 are uniform or not. For example, where the first layer 110 is thicker, the second layer 120 may be thinner. The combined layer 190 may include a maximum thickness 199. As shown in FIG. 1-1, the maximum thickness 199 may be located at the edges 116, 126 of the first and second layers 110, 120.

The structure 101 may be attached to one or more electronic components. For example, a printed circuit board (not shown) may be attached to at least a portion of the innermost surface 122 of the second layer 120. In some embodiments, at least a portion of the innermost surface 122 of the second layer 120 may not be abutting any other surface, whether the printed circuit board or otherwise, such that the innermost surface 122 of the second layer 120 is the innermost surface 192 of the structure 101.

FIG. 1-1-1 is a partial cross-sectional side view along line 1-1 of FIG. 1 of another embodiment of a structure 101-1 for housing electronic components. The structure 101-1 of FIG. 1-1-1 may be similar to the structure 101 of FIG. 1-1. Like numbers indicate like elements. For example, the structure 101-1 may include a first layer 110-1 and a second layer 120-1. In another example, as shown in FIG. 1-1-1, the first layer 110-1 and/or second layer 120-1 may include one or more horizontal planar portions 114-1, 124-1 and/or one or more vertical planar portions 115-1, 125-1, respectively, which may be joined at edges 116-1, 126-1. In a further example, the structure 101-1 may be attached to one or more electronic components, as described herein.

The structure 101-1 of FIG. 1-1-1 may differ from the structure 101 of FIG. 1-1. For example, one or more of the peripheral edges 113-1 of the first layer 110-1 and one or more of the peripheral edges 123-1 of the second layers 120-1 may not be coterminous. As shown in FIG. 1-1-1, the innermost surface 112-1 of the first layer 110-1 abuts one or more of the peripheral edges 123-1 of the second layer 120-1. Thus, the outermost surface 111-1 of the first layer 110-1 may be an outermost surface 191-1 of a combined layer 190-1 for the entire outer surface of the structure 101-1. Additionally, one or more of the peripheral edges 113-1 may be considered innermost surfaces of the first layer 110-1

The first layer 110-1 and the second layer 120-1 may be affixed together. For example, at least a portion of the innermost surface 112-1 of the first layer 110-1 may be affixed to at least a portion of the outermost surface 121-1 of the second layer 120-1.

As with the structure 101 of FIG. 1-1, the innermost surface 122-1 of the second layer 120-1 may abut and/or be affixed to at least a portion of the display 102 of the mobile device 100. For example, at least a portion of one or more of the vertical planar portions 125-1 of the second layer 120-1 and/or at least a portion of one or more of the peripheral edges 113-1 of the first layer 110-1 may abut at least a portion of the display 102.

The first layer 110-1 and the second layer 120-1 may each have a thickness 118-1, 128-1, respectively. As shown in FIG. 1-1-1, the thickness 118-1 of the first layer 110-1 and/or the thickness 128-1 of the second layer 120-1 may be uniform along at least a portion of the horizontal planar portions 114-1, 124-1 of the first layer 110-1 and the second layer 120-1, respectively, and at least a portion of the vertical planar portions 115-1, 125-1 of the first layer 110-1 and the second layer 120-1, respectively. In other embodiments, the thicknesses 118-1, 128-1 of the first layer 110-1 and/or second layer 120-1 may vary along one or more of the planar portions 114-1, 115-1, 124-1, 125-1.

The first layer 110-1 and second layer 120-1 may include maximum thicknesses 119-1, 129-1, respectively. As shown in FIG. 1-1-1, the maximum thickness 119-1 of the first layer 110-1 may be located where the innermost surface 112-1 of the first layer 110-1 abuts one or more of the peripheral edges 123-1 of the second layer 120-1 and the maximum thickness 129-1 of the second layer 120-1 may be located at the edge 126-1 of the second layer 120-1.

The first layer 110-1 and the second layer 120-1 may define the combined layer 190-1. The combined layer 190-1 may include the outermost surface 191-1, an innermost surface 192-1, and one or more peripheral edges 193-1. As shown in FIG. 1-1-1, the outermost surface 111-1 of the first layer 110-1 may define the outermost surface 191-1 of the combined layer 190-1, the innermost surface 122-1 of the second layer 120-1 and the peripheral edges 113-1 may define the innermost surface 192-1 of the combined layer 190-1, and a portion of the first layer 110-1 (e.g., the outermost surface 111-1) where the innermost surface 112-1 of the first layer 110-1 abuts one or more of the peripheral edges 123-1 of the second layer 120-1 may define one or more peripheral edges 193-1 of the combined layer 190-1. In other embodiments, other portions of surfaces and/or portions of peripheral edges may be the outermost surface 191-1, the innermost surface 192-1, one or more of the peripheral edges 193-1, or combinations thereof.

The combined layer 190-1 may include a thickness 198-1. The thickness 198-1 may be measured from the innermost surface 191-1 of the combined layer 190-1 to the outermost surface 192-1 of the combined layer 190-1. The combined layer 190-1 may include a maximum thickness 199-1 that may be located at the edges 116-1, 126-1 of the first and second layers 110-1, 120-1.

One or more elements of the structure 101 or any other structure described herein may be incorporated into the structure 101-1 of FIG. 1-1-1 and vice versa. For example, one or more peripheral edges 193-1 of the combined layer 190-1 may be replaced with at least a portion of one or more peripheral edges 193 of the combined layer 190.

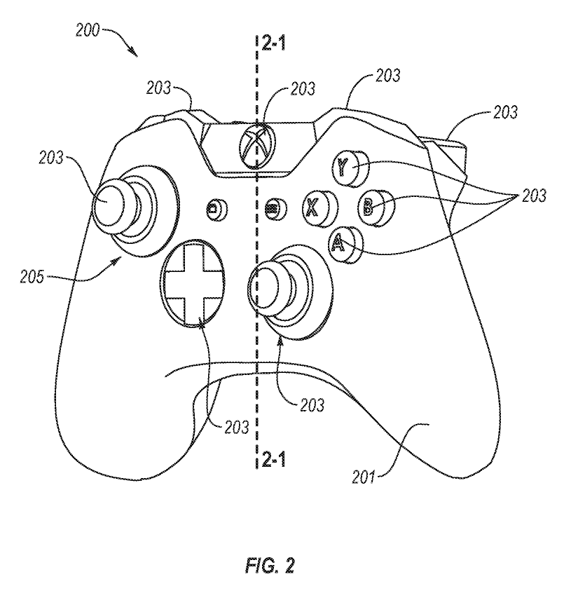

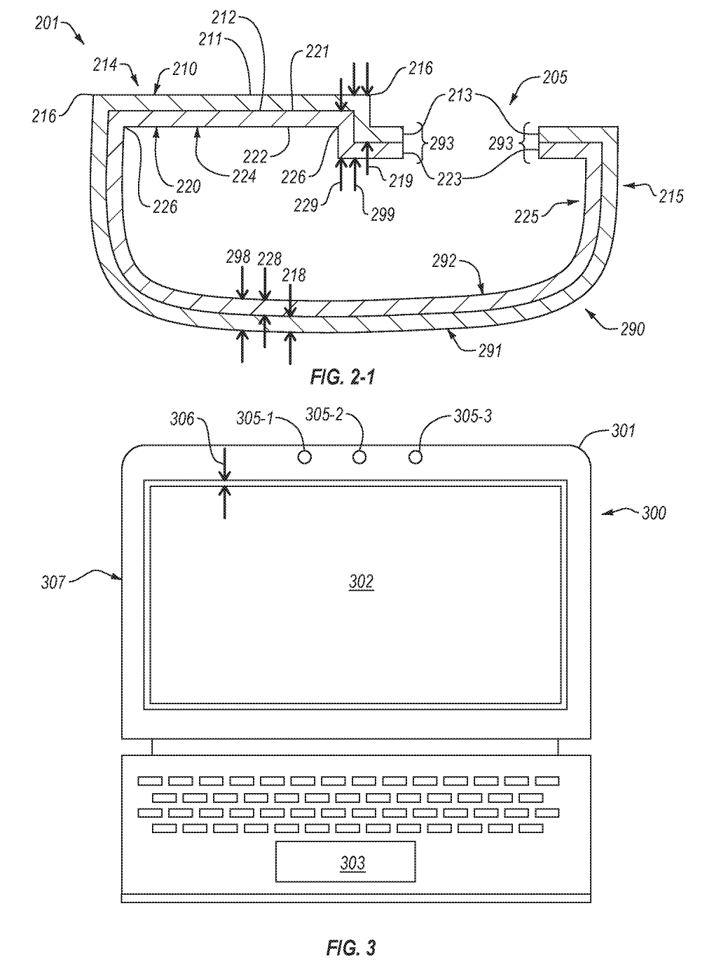

FIG. 1-1-2 is a partial cross-sectional side view along line 1-1 of FIG. 1 of yet another embodiment of a structure 101-2 for housing electronic components. The structure 101-2 of FIG. 1-1-2 may be similar to the structures 101 and/or 101-1 of FIGS. 1-1 and 1-1-1. Like numbers indicate like elements. For example, the structure 101-2 may include a first layer 110-2 and a second layer 120-2 that define a combined layer 190-2. In another example, as shown in FIG. 1-1-2, the innermost surface 112-2 of the first layer 110-2 abuts one or more of the peripheral edges 123-2 of the second layer 120-2.

The structure 101-2 of FIG. 1-1-2 may differ from the structures 101, 101-1 of FIGS. 1-1 and 1-1-1. For example, as shown in FIG. 1-1-2, the innermost surface 112-2 of the first layer 110-2 abuts one or more of the peripheral edges 123-2 of the second layers 120-2 and a portion of the innermost surface 122-2 of the second layer 120. Thus, like the structure 101-1 of FIG. 1-1-1, the outermost surface 111-2 of the first layer 110-2 may be an outermost surface 191-2 of a combined layer 190-2 for the entire outer surface of the structure 101-2 and/or a portion of the first layer 110-2 (e.g., the outermost surface 111-2) where the innermost surface 112-2 of the first layer 110-2 abuts one or more of the peripheral edges 123-2 of the second layer 120-2 define one or more peripheral edges 193-2 of the combined layer 190-2.

Unlike the structure 101-1 of FIG. 1-1-1, a portion of the outermost surface 111-2 of the first layer 110-2 that abuts the innermost surface 122-2 of the second layer 120-2 may be considered an innermost surface 192-2 of the combined layer 190-2. As shown in FIG. 1-1-2, one or more of the peripheral edges 113-2 may abut the innermost surface 122-2 of the second layer 120-2. In other embodiments, one or more of the peripheral edges 113-2 may be adjacent to but not abut the innermost surface 122-2 of the second layer 120-2.

The first layer 110-2 and the second layer 120-2 may be affixed together. For example, at least a portion of the innermost surface 112-2 of the first layer 110-2 may be affixed to at least a portion of the outermost surface 121-2 of the second layer 120-2.

As with the structure 101 of FIG. 1-1, the innermost surface 122-2 of the second layer 120-2 may abut and/or be affixed to at least a portion of the display 102 of the mobile device 100. For example, at least a portion of one or more of the vertical planar portions 115-2 of the first layer 110-2, one or more of the vertical planar portions 125-2 of the second layer 120-2, at least a portion of one or more of the peripheral edges 113-2 of the first layer 110-2, or combinations thereof may abut at least a portion of the display 102.

The first layer 110-2 and the second layer 120-2 may each have a thickness 118-2, 128-2, respectively. As shown in FIG. 1-1-2, the thickness 118-2 of the first layer 110-2 and/or the thickness 128-2 of the second layer 120-2 may be uniform along at least a portion of the horizontal planar portions 114-2, 124-2 of the first layer 110-2 and the second layer 120-2, respectively, and at least a portion of the vertical planar portions 115-2, 125-2 of the first layer 110-2 and the second layer 120-2, respectively. In other embodiments, the thicknesses 118-2, 128-2 of the first layer 110-2 and/or second layer 120-2 may vary along one or more of the planar portions 114-2, 115-2, 124-2, 125-2.

The first layer 110-2 and second layer 120-2 may include maximum thicknesses 119-2, 129-2, respectively. As shown in FIG. 1-1-2, the maximum thickness 119-2 of the first layer 110-2 may be located where the innermost surface 112-2 of the first layer 110-2 abuts one or more of the peripheral edges 123-2 of the second layer 120-2 and the maximum thickness 129-2 of the second layer 120-2 may be located at the edge 126-2 of the second layer 120-2.

The combined layer 190-2 may include a thickness 198-2. The thickness 198-2 may be measured from the innermost surface 192-2 of the combined layer 190-2 to the outermost surface 191-2 of the combined layer 190-2. The combined layer 190-2 may include a maximum thickness 199-2 that may be located at the edges 116-2, 126-2 of the first and second layers 110-2, 120-2.

One or more elements of the structures 101, 101-1, 101-2 or any other structure described herein may be incorporated into the structure 101-2 of FIG. 1-1-2 and vice versa. For example, one or more peripheral edges 193-2 of the combined layer 190-2 may be replaced with at least a portion of one or more peripheral edges 193, 193-1 of the combined layers 190, 190-1 of structures 101, 101-1.

FIG. 1-1-3 is a partial cross-sectional side view along line 1-1 of FIG. 1 of a further embodiment of a structure 101-3 for housing electronic components. The structure 101-3 of FIG. 1-1-3 may be similar to the structures 101, 101-1, 101-2 of FIGS. 1-1, 1-1-1, and 1-1-2. Like numbers indicate like elements. For example, the structure 101-3 may include a first layer 110-3 and a second layer 120-3. In another example, as shown in FIG. 1-1-3, the innermost surface 112-3 of the first layer 110-3 abuts one or more of the peripheral edges 123-1 of the second layers 120-1, similar to the structures 101-1, 101-2 of FIGS. 1-1-1 and 1-1-2.

The structure 101-3 of FIG. 1-1-3 may differ from the structures 101, 101-1, 101-2 of FIGS. 1-1, 1-1-1, and 1-1-2. For example, as shown in FIG. 1-1-3, the structure 101-3 may include a third layer 130-3. The first layer 110-3, the second layer 120-3, and the third layer 130-3 may form the combined layer 190-3.

The first, second, and third layers 110-3, 120-3, 130-3 may be formed of the various materials described above. For example, the first layer 110-3 may be formed of a textile material, the second layer 120-3 may be formed of a plastic and/or metallic material, and the third layer 130-3 may be formed of a foam. In one example, the moduli of elasticity of the first, second, and third layers 110-3, 120-3, 130-3 may each be less than 2.41 MPa individually, but when affixed as described above, the combined layer 190-3 may have a modulus of elasticity that is less than 2300 MPa, more than 25 GPa, 45 GPa, or any values therebetween.

The third layer 130-3 may include an outermost surface 131-3, an innermost surface 132-3, and one or more peripheral edges 133-3. The third layer 130-3 may include one or more horizontal planar portions 134-3 and/or one or more vertical planar portion 135-3.

The outermost surface 131-3 and the innermost surface 132-3 of the third layer 130-3 are shown as being completely enclosed by the first layer 110-3 and the second layer 120-3, such that the third layer 130-3 does not form either the outermost surface 191-3 or the innermost surface 192-3 of the combined layer 190-3. In other embodiments, at least a portion of the third layer 130-3 may serve as at least a portion of one or more of the outermost surface 191-3 and the innermost surface 192-3. For example, if a third layer, such as third layer 130-3, were added between the first and second layers 110, 120 in FIG. 1-1, its peripheral edges (e.g., peripheral edges 133) may at least partially define the peripheral edge 193 of the combined layer 190.

The structure 101-3 of FIG. 1-1-3 may be similar to the structure 101-1 of FIG. 1-1-1. For example, as shown in FIG. 1-1-3, the innermost surface 112-3 of the first layer 110-3 abuts one or more of the peripheral edges 123-3 of the second layer 120-3. Thus, the outermost surface 111-3 of the first layer 110-3 may be an outermost surface 191-3 of the combined layer 190-3 for the entire outer surface of the structure 101-3. The peripheral edges 113-3 may be considered innermost surfaces of the first layer 110-3 and/or combined layer 190-3. A portion of the first layer 110-3 (e.g., the outermost surface 111-3) where the innermost surface 112-3 of the first layer 110-3 abuts one or more of the peripheral edges 123-3 of the second layer 120-3 and/or one or more of the peripheral edges 133-3 of the third layer 130-3 may define one or more peripheral edges 193-3 of the combined layer 190-3. In other embodiments, other portions of surfaces and/or portions of peripheral edges may be the outermost surface 191-3, the innermost surface 192-3, one or more of the peripheral edges 193-3, or combinations thereof.

At least a portion of one or more of the first, second, and third layers 110-3, 120-3, 130-3 may be affixed together. For example, as shown in FIG. 1-1-3, at least a portion of the innermost surface 112-3 of the first layer 110-3 may be affixed to at least a portion of the second layer 120 (e.g., at one or more of the peripheral edges 123-3 of the second layer 120-3). In another example, at least a portion of the innermost surface 112-3 of the first layer 110-3 may be affixed to at least a portion of the third layer 130-3 (e.g., at one or more of the peripheral edges 133-3 of the third layer 130-3). In a further example, the first layer 110-3 may extend around at least a portion of the innermost surface 122-3 of the second layer 120-3 and be affixed to at least a portion thereof.

As with the structure 101-1 of FIG. 1-1-1, the innermost surface 122-3 of the second layer 120-3 may abut and/or be affixed to at least a portion of the display 102 of the mobile device 100. For example, at least a portion of one or more of the vertical planar portions 125-3 of the second layer 120-3, at least a portion of the peripheral edge 113-3 of the first layer 110-3, or combinations thereof may abut at least a portion of the display 102.

The first layer 110-3, the second layer 120-3, the third layer 130-3 may each have a thickness 118-3, 128-3, 138-3, respectively. As shown in FIG. 1-1-3, the thickness 118-3 of the first layer 110-3, the thickness 128-3 of the second layer 120-3, and the thickness 138-3 of the third layer 130-3 may be uniform along at least a portion of the horizontal planar portions 114-3, 124-3, 134-3 of the first, second, and third layers 110-3, 120-3, 130-3, respectively, and at least a portion of the vertical planar portions 115-3, 125-3, 135-3 of the first, second, and third layers 110-3, 120-3, 130-3, respectively. In other embodiments, the thicknesses 118-3, 128-3, 138-3 of the first, second, and third layers 110-3, 120-3, 130-3, respectively may vary along one or more of the planar portions 114-3, 115-3, 124-3, 125-3, 134-3, 135-3.

The first, second, and third layers 110-3, 120-3, 130-3 may include maximum thicknesses 119-3, 129-3, 139-3 respectively. As shown in FIG. 1-1-3, the maximum thickness 119-3 of the first layer 110-3 may be located where the innermost surface 112-3 of the first layer 110-3 abuts the peripheral edge 123-3 of the second layer 120-3, the maximum thickness 129-3 of the second layer 120-3 may be located at the edge 126-3 of the second layer 120-3, and the maximum thickness 139-3 of the third layer 130-3 may be located at the edge 136-3 of the third layer 130-3.

The combined layer 190-3 may include a thickness 198-3. The thickness 198-3 may be measured from the innermost surface 192-3 of the combined layer 190-3 to the outermost surface 191-3 of the combined layer 190-3. The combined layer 190-3 may include a maximum thickness 199-3 that may be located at the edges 116-3, 126-3, 136-3 of the first, second, and third layers 110-3, 120-3, 130-3.

One or more elements of the structures 101, 101-1, 101-2, 101-3 or any other structure described herein may be incorporated into the structure 101-3 of FIG. 1-1-3 and vice versa. For example, one or more peripheral edges 193-3 of the combined layer 190-3 may be replaced with at least a portion of one or more peripheral edges 193, 193-1, 193-2 of the combined layers 190, 190-1 of structures 101, 101-1, 101-2.

FIG. 1-1-4 is a partial cross-sectional side view along line 1-1 of FIG. 1 of a yet further embodiment of a structure 101-4 for housing electronic components. The structure 101-4 of FIG. 1-1-4 may be similar to and/or may differ from the structures 101, 101-1, 101-2, and 101-3 of FIGS. 1-1, 1-1-1, 1-1-2, and 1-1-3. Like numbers indicate like elements. For example, as shown in FIG. 1-1-4, the structure 101-4 may include first and second layers 110-4, 120-4 and may include a third layer. The third layer may be an input sensor 180-4. The input sensor 180-4 may be used as a portion of a capacitive touch area 104-4. The first layer 110-4, the second layer 120-4, and the input sensor 180-4 may form a combined layer 190-4.

At least a portion of one or more of the first layer 110-4, the second layer 120-4, and the input sensor 180-4 may be affixed together. For example, as shown in FIG. 1-1-4, at least a portion of an innermost surface 112-4 of the first layer 110-4 may be affixed to at least a portion of the second layer 120 (e.g., at one or more of the peripheral edges 123-4 of the second layer 120-4). In another example, at least a portion of the innermost surface 112-4 of the first layer 110-4 may be affixed to at least a portion of the input sensor 180-4 (e.g., at one or more peripheral edges 183-4 of the input sensor 180-4). In a further example, the first layer 110-4 may extend around at least a portion of the innermost surface 122-4 of the second layer 120-4 and be affixed to at least a portion thereof.

The input sensor 180-4 may include an outermost surface 181-4, an innermost surface 182-4, and the one or more peripheral edges 183-4. The input sensor 180-4 may include one or more vertical planar portion 184-5.

The outermost surface 181-4 and the innermost surface 182-4 are shown as being completely enclosed by the first layer 110-4 and the second layer 120-4, such that the input sensor 180-4 does not form either the outermost surface 191-4 or the innermost surface 192-4 of the combined layer 190-4. In other embodiments, at least a portion of the input sensor 180-4 may serve as at least a portion of one or more of the outermost surface 191-4 and the innermost surface 192-4.

The structure 101-4 of FIG. 1-1-4 may be similar to the structure 101-1 of FIG. 1-1-1. For example, as shown in FIG. 1-1-4, the innermost surface 112-4 of the first layer 110-4 abuts one or more of the peripheral edges 123-4 of the second layer 120-4. Thus, the outermost surface 111-4 of the first layer 110-4 may be an outermost surface 191-4 of the combined layer 190-4 for the entire outer surface of the structure 101-4. The peripheral edges 113-4 may be considered innermost surfaces of the first layer 110-4 and/or combined layer 190-4. A portion of the first layer 110-4 (e.g., the outermost surface 111-4) where the innermost surface 112-4 of the first layer 110-4 abuts one or more of the peripheral edges 123-4 of the second layer 120-4 and/or one or more of the peripheral edges 183-4 of the input sensor 180-4 may define one or more peripheral edges 193-4 of the combined layer 190-4.

As with the structure 101-1 of FIG. 1-1-1, the innermost surface 122-4 of the second layer 120-4 may abut and/or be affixed to at least a portion of the display 102 of the mobile device 100. For example, at least a portion of one or more of the vertical planar portions 115-4 of the first layer 110-4, one or more of the vertical planar portions 125-4 of the second layer 120-4, at least a portion of the peripheral edge 113-4 of the first layer 110-4, or combinations thereof may abut at least a portion of the display 102.

The first layer 110-4, the second layer 120-4, the input sensor 180-4 may each have a thickness 118-4, 128-4, 188-4, respectively. As shown in FIG. 1-1-4, the thickness 118-4 of the first layer 110-4, the thickness 128-4 of the second layer 120-4, and the thickness 188-4 of the input sensor 180-4 may be uniform along at least a portion of the vertical planar portions 115-4, 125-4, 185-4 of the first and second layers 110-4, 120-4 and the input sensor 180-4, respectively. The thickness 118-4 of the first layer 110-4 and the thickness 128-4 of the second layer 120-4 may be uniform along at least a portion of the horizontal planar portions 114-4, 124-4, of the first and second layers 110-4, 120-4, respectively. In other embodiments, the thicknesses 118-4, 128-4, 188-4 of the first and second layers 110-4, 120-4 and the input sensor 180-4, respectively may vary along one or more of the planar portions 114-4, 115-4, 124-4, 125-4, 185-4.

The first and second layers 110-4, 120-4 and the input sensor 180-4 may include maximum thicknesses 119-4, 129-4, 189-4 respectively. As shown in FIG. 1-1-4, the maximum thickness 119-4 of the first layer 110-4 may be located where the innermost surface 112-4 of the first layer 110-4 abuts the peripheral edge 123-4 of the second layer 120-4 and the peripheral edge 183-4 of the input sensor 180-4, the maximum thickness 129-4 of the second layer 120-4 may be located at the edge 126-4 of the second layer 120-4, and the maximum thickness 189-4 of the input sensor 180-4 may be located between the outermost surface 181-4 and the innermost surface 182-4 of the input sensor 180-4.

The combined layer 190-4 may include a thickness 198-4. The thickness 198-4 may be measured from the innermost surface 192-4 of the combined layer 190-4 to the outermost surface 191-4 of the combined layer 190-4. The combined layer 190-4 may include a maximum thickness 199-4 that may be located at the through the first and second layers 110-4, 120-4 and the input sensor 180-4.

Although the structures 101, 101-1, 101-2, 101-3, 101-4 are shown with two or three layers, additional layers may be provided between the first and second layers. For example, a third, fourth, and fifth layer may be included between at least a portion of the first and second layers. More layers may be included. In at least one embodiment, at least a portion of each layer may be affixed to at least a portion of an adjacent layer. In at least one embodiment, an outermost layer and an innermost layer may be at least partially affixed, though one or more inner layers may remain disconnected.

As stated above, one or more elements of one or more of the structures 101, 101-1, 101-2, 101-3, 101-4 may be incorporated into each other. For example, a structure may include two layers for one portion and three or more layers for another portion. In another example, a structure may include an overlapping first layer, like the surfaces in the vertical planar portion 125-2 of FIG. 1-1-2 while including an input sensor, like input sensor 180-4 of FIG. 1-1-4, between a first and second layer with coterminous peripheral edges, like the first and second layers 110, 120 of FIG. 1-1. Any permutation of the components of the structures 101, 101-1, 101-2, 101-3, 101-4 may be incorporated into each other.

One or more elements of the structures 101, 101-1, 101-2, 101-3, 101-4 or any other structure described herein may be incorporated into the structure 101-4 of FIG. 1-1-4 and vice versa. For example, one or more input sensors 180-4 may be included at various locations of structures 101, 101-1, 101-2, 101-3.

Referring now to FIG. 2, a conceptual drawing of an embodiment of a video game controller 200 is shown. The video game controller 200 includes a structure 201 for housing various electronic components. For example, the structure 201 may house a processor, memory, battery, transceiver, servos, sensors, other internal components, or combinations thereof may be associated with the video game controller 200.

The video game controller 200 may include one or more inputs 203. The inputs 203 may be used to interact with a user. In the present embodiment, the input 203 may be used to interact with a video game console or computing device. One or more of the inputs 203 may extend through one or more apertures 205 in the structure 201.

FIG. 2-1 is a partial cross-sectional side view along line 2-1 in FIG. 2 of the structure 201 of the video game controller 200. The structure 201 may include a first layer 210 and a second layer 220. In other embodiments, more layers may be included. The structure 201 of FIG. 2-1 may be similar to and/or may differ from the structures 101, 101-1, 101-2, 101-3, 101-4 of FIGS. 1-1, 1-1-1, 1-1-2, 1-1-3, and 1-1-4. Like numbers indicate like elements. One or more elements of the structures 101, 101-1, 101-2, 101-3, 101-4 or any other structure described herein may be incorporated into the structure 201 of FIGS. 2 and 2-1 and vice versa.

The first layer 210 and the second layer 220 include outermost surfaces 211, 221 and innermost surfaces 212, 222, respectively. The first layer 210 and the second layer 220 may be at least partially affixed together. For example, at least a portion of the innermost surface 212 of the first layer 210 may be affixed to at least a portion of the outermost surface 221 of the second layer 220.

The first layer 210 and the second layer 220 may include one or more peripheral edges and/or surfaces 213, 223, respectively. As shown in FIG. 2-1, the peripheral edges 213, 223 may be coterminous (e.g., end at the same point). In some embodiments, only two of the peripheral edges 213, 223 may be coterminous while two other peripheral edges 213, 223 may not be coterminous. In further embodiments, none of the peripheral edges 213, 223 may be coterminous. For example, as shown in FIGS. 1-1-1, 1-1-2, 1-1-3, and 1-1-4, various edge configurations may be used.

As shown in FIG. 2-1, the first layer 210 and/or second layer 220 may include one or more horizontal (or near horizontal) planar portions 214, 224 and/or one or more vertical (or near vertical) planar portions 215, 225, respectively. The planar portions 214, 215, 224, 225 may be joined at edges 216, 226. In some embodiments, a structure may not include any planar surfaces.

The first layer 210 and the second layer 220 may each have a thickness 218, 228, respectively. As shown in FIG. 2-1, the thickness 218 of the first layer 210 and/or the thickness 228 of the second layer 220 may be uniform (e.g., approximately the same) along one or more of the planar portions 214, 215 of the first layer 210 and/or the planar portions 224, 225 of the second layer 220. In other embodiments, the thicknesses 218, 228 of the first layer 210 and/or second layer 220 may vary along one or more of the planar portions 214, 215, 224, 225 and/or other portions.

The first layer 210 and second layer 220 may include maximum thicknesses 219, 229, respectively. The maximum thicknesses 219, 229 of the present embodiment may be located, as shown in FIG. 2-1, at the combined edges 216, 226 of the first and second layers 210, 220. In other embodiments, the maximum thicknesses 219, 229 may be found at other portions of the first and/or second layers 210, 220.

The first layer 210 and the second layer 220 may define a combined layer 290. The combined layer 290 may include an outermost surface 291, an innermost surface 292, and one or more peripheral edges 293. As shown in FIG. 2-1, the outermost surface 211 of the first layer 210 is the outermost surface 291 of the combined layer 290, the innermost surface 222 of the second layer 220 is the innermost surface 292 of the combined layer 290, and both of the peripheral edges 213, 223 of the first and second layers 210, 220 define the peripheral edges 293 of the combined layer 290. In other embodiments, other portions of surfaces and/or portions of peripheral edges may be the outermost surface 291, the innermost surface 292, one or more of the peripheral edges 293, or combinations thereof.

The combined layer 290 may include a combined thickness 298. The thickness 298 may be measured from the outermost surface 291 of the combined layer 290 to the innermost surface 292 of the combined layer 290. The thickness 298 may be uniform along one or more of the planar portions 214, 215, 224, 225 of the first and second layers 210, 220 whether the thicknesses 218, 228 of the first and second layers 210, 220 are uniform or not. For example, where the first layer 210 is thicker, the second layer 220 may be thinner. The combined layer 290 may include a maximum thickness 299. The maximum thickness 299 of the present embodiment may be located, as shown in FIG. 2-1, at the combined edges 216, 226 of the first and second layers 210, 220.

The structure 201 may be attached to one or more electronic components. For example, a printed circuit board (not shown) may be attached to at least a portion of the innermost surface 222 of the second layer 220. For example, a servo or other component, may be mounted to a portion of the innermost surface 222 of the second layer 220 and to the input 203. In some embodiments, at least a portion of the innermost surface 222 of the second layer 220 may not be abutting any other surface, whether the printed circuit board or otherwise, such that the innermost surface 222 of the second layer 220 is the innermost surface 292 of the structure 201.

FIG. 3 is a conceptual drawing of an embodiment of a computing device 300. The computing device 300 may include a structure 301 for housing various electronic components. The structure 301 may be similar to other structures described herein. Like numbers indicate like elements.

The computing device 300 is illustrated as a laptop-type computing device. In other embodiments, the computing device 300 may be a desktop computing device with an attached monitor, may be a gaming system with an attached monitor and/or attached peripherals, or may be another computing device. One or more elements of one or more of the structures 101, 101-1, 101-2, 101-3, 101-4, 201 may be incorporated into the structure 301 of FIG. 3 and vice versa.

The computing device 300 may include an input device 303 that may be used to interact with a user. The input device 303 may include a keyboard, mouse, trackpad, other input, or combinations thereof.

The computing device 300 may include a monitor 307. The monitor 307 may be attached to an input device 303. In other embodiments, the monitor 307 may be physically detached, but in electronic communication with the input device 303. In further embodiments, the monitor 307 may be detachable from the input device 303. The monitor 307 may include a display 302. The display 302 may display information (e.g., in a standard monitor) and/or act as an input (e.g., a touch screen monitor).

The monitor 307 may have a gap 306 between the display 302 and the structure 301. At least one embodiment of a structure for housing electronic components described herein may reduce a gap (e.g., display gap 306 shown in FIG. 3) between an edge of the display (e.g., display 302) and the structure 301. In some embodiments, the gap may range from about 0.05 mm to about 2 mm or any value therebetween. The monitor 307 may include one or more apertures 305-1, 305-2, 305-3 for image or other sensors (not shown).

FIG. 3-1 is a perspective isometric view of the structure 301 of the monitor 307 without the display 302. The structure 301 may include a pocket with a lip extending into the pocket. Apertures 305-1, 305-2, 305-3 may extend through the structure 301 into the pocket.

FIG. 3-1-1 is a partial cross-sectional side view at 3-1-1 along line 3-1 in FIG. 3-1 of an embodiment of a structure 301-1 of the monitor 307. The structure 301-1 may include a first layer 310-1, a second layer 320-1, and a third layer 330-1. In other embodiments, more or fewer layers may be included. The structure 301-1 of FIG. 3-1-1 may be similar to and/or may differ from the structures 101, 101-1, 101-2, 101-3, 101-4, 201 of FIGS. 1-1, 1-1-1, 1-1-2, 1-1-3, 1-1-4, 2, and 2-1. Like numbers indicate like elements. One or more elements of one or more of the structures 101, 101-1, 101-2, 101-3, 101-4, 201 may be incorporated into the structure 301-1 of FIG. 3-1 and vice versa.

The structure 301-1 of FIG. 3-1-1 may be similar to the structure 101-3 of FIG. 1-1-3. For example, the structure 301-1 may include a first, second, and third layer 310-1, 320-1, 330-1, respectively. For ease of description, the first, second, and third layers 310-1, 320-1, 330-1 may include outermost surfaces 311-1, 321-1, 331-1, innermost surfaces 312-1, 322-1, 332-1, one or more peripheral edges 313-1, 323-1, 333-1, edges 316-1, 326-1, 336-1, thicknesses 318-1, 328-1, 338-1, maximum thicknesses 319-1, 329-1, 339-1, or combinations thereof, respectively. The first layer 310-1, the second layer 320-1, and the third layer 330-1 may form a combined layer 390-1. The combined layer 390-1 may include a combined thickness 398-1. The thickness 398-1 may be measured from the innermost surface 392-1 of the combined layer 390-1 to the outermost surface 391-1 of the combined layer 390-1. The combined layer 390-1 may include a maximum thickness 399-1 that may be located at the edges 316-1, 326-1, 336-1 of the first, second, and third layers 310-1, 320-1, 330-1.

The structure 301-1 may differ from the structure 101-3 of FIGS. 1-1-3. For example, as shown in FIG. 3-1-1, the structure 301-1 may include multiple horizontal planar portions 394-1 (e.g., which may include one or more layers). The horizontal planar portion 394-1 near the peripheral edges 313-1, 323-1, 333-1 may act as a retention mechanism. For example, the display 302 may be at least partially inserted behind the horizontal planar portion 394-1.

The outermost surface 331-1 and the innermost surface 332-1 of the third layer 330-1 are shown as being completely enclosed by the first layer 310-1 and the second layer 320-1, such that the third layer 330-1 does not form either the outermost surface 391-1 or the innermost surface 392-1 of the combined layer 390-1.

The structure 301-1 of FIG. 3-1-1 may be similar to the structure 101-1 of FIG. 1-1-1. For example, as shown in FIG. 3-1-1, the innermost surface 312-1 of the first layer 310-1 abuts one or more of the peripheral edges 323-1 of the second layer 320-1. Thus, the outermost surface 311-1 of the first layer 310-1 may be an outermost surface 391-1 of the combined layer 390-1 for the entire outer surface of the structure 301-1. The peripheral edges 313-1 may be considered innermost surfaces of the first layer 310-1. A portion of the first layer 310-1 (e.g., the outermost surface 311-1) where the innermost surface 312-1 of the first layer 310-1 abuts one or more of the peripheral edges 323-1 of the second layer 320-1 and/or one or more of the peripheral edges 333-1 of the third layer 330-1 may define one or more peripheral edges 393-1 of the combined layer 390-1. In other embodiments, other portions of surfaces and/or portions of peripheral edges may be the outermost surface 391-1, the innermost surface 392-1, one or more of the peripheral edges 393-1, or combinations thereof.

At least a portion of one or more of the first, second, and third layers 310-1, 320-1, 330-1 may be affixed together. As with the structure 101-1 of FIG. 1-1-1, the innermost surface 322-1 of the second layer 320-1 may abut and/or be affixed to at least a portion of the display 302 of the mobile device 300. For example, at least a portion of one or more of the vertical planar portions 315-1 of the first layer 310-1, one or more of the vertical planar portions 325-1 of the second layer 320-1, at least a portion of the peripheral edge 313-1 of the first layer 310-1, or combinations thereof may abut at least a portion of the display 302.

FIG. 3-2-1 is a partial cross-sectional side view at 3-2-1 along line 3-1 in FIG. 3-1 of the embodiment of the structure 301-1 of the monitor 307 in FIG. 3-1-1. The structure 301-1 may decrease in layers toward the middle of the structure 301-1. As can be seen in FIG. 3-2-1, the structure 301-1 decreases by one layer from near the peripheral edge 393-1 of the combined layer 390-1 where there are three layers (e.g., first, second, and third layers 310-1, 320-1, 330-1) toward the middle where there are two layers (e.g., first and second layers 310-1, 320-1). In other embodiments, the structure 301-1 may increase in layers from near the peripheral edge 393-1 of the combined layer 390-1 toward the middle of the structure 301-1. In further embodiments, the structure 301-1 may increase and/or decrease one or more times from near the peripheral edge 393-1 of the combined layer 390-1 toward the middle of the structure 301-1.

FIG. 3-1-2 is a partial cross-sectional side view at 3-1-1 along line 3-1 in FIG. 3-1 of another embodiment of a structure 301-2 of the monitor 307. The structure 301-2 may be similar to the structure 301-1 shown in FIGS. 3-1-1 and 3-2-1. For ease of description, the first, second, and third layers 310-2, 320-2, 330-2 may include similar surfaces, edges, dimensions, etc., which are similarly numbered. The structure 301-2 may further include a fourth layer 340-2. The fourth layer 340-2 may include an outermost surface 341-2, an innermost surface 342-2, a peripheral edge 343-2, a horizontal planar portion 344-2, a thickness 348-2, and a maximum thickness 349-2. The peripheral edge 343-2 may be spaced apart from yet directly adjacent to, may abut, or may be otherwise positioned relative to the peripheral edge 333-2 of the third layer 330-2. One or more elements of one or more of the structures 101, 101-1, 101-2, 101-3, 101-4, 201, 301, 301-1 may be incorporated into the structure 301-2 of FIGS. 3-1-2 and 3-2-2 and vice versa.

FIG. 3-2-2 is a partial cross-sectional side view at 3-2-1 along line 3-1 in FIG. 3-1 of the embodiment of the structure 301-2 of the monitor 307 in FIG. 3-1-2. Unlike the structure 301-1 shown in FIG. 3-2-1, the structure 301-2 may maintain a similar thickness while changing one or more layers from near the peripheral edge 393-2 toward the middle of the structure 301-2. For example, as shown the combined layer 390-2 may transition from the third layer 330-2 to the fourth layer 340-2.

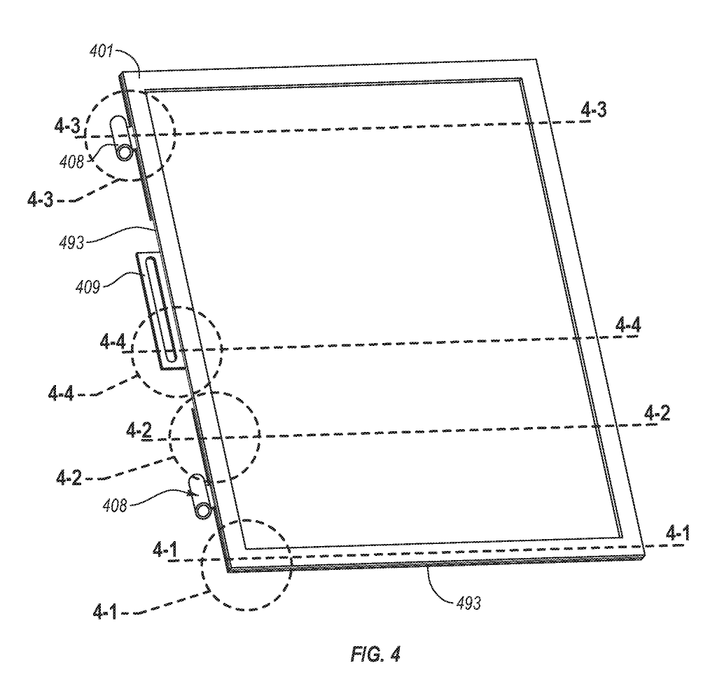

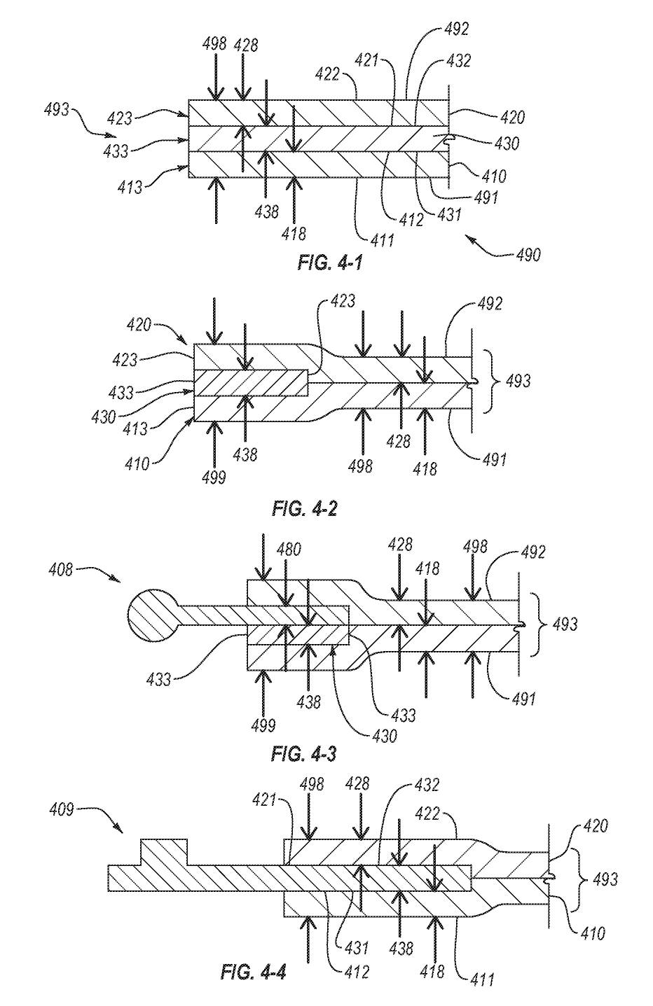

FIG. 4 is a perspective, isometric view of an embodiment of a structure 401 for housing electronic components. One or more elements of one or more of the structures 101, 101-1, 101-2, 101-3, 101-4, 201, 301, 301-1, 301-2 may be incorporated into the structure 401 of FIG. 4 and vice versa.

The structure 401 may be a keyboard that is configured to connect to a monitor, such as monitor 307. The structure 401 may include one or more connectors 408 that may connect to another structure. The connectors 408 may be hinges (e.g., friction hinges), magnetic connectors, other connectors, or combinations thereof. The structure 401 may include an electrical connector 409. The electrical connector 409 may include a flexible printed circuit, a display port, one or more wires, other electrical connectors, or combinations thereof.

FIG. 4-1 is a partial cross-sectional side view at 4-1 of an embodiment of the structure 401 of FIG. 4 about line 4-1 at a connection of two peripheral edges 493 (best seen in FIG. 4) of a combined layer 490. The structure 401 may include a first layer 410, a second layer 420, and a third layer 430. In other embodiments, more or fewer layers may be included.

The structure 401 of FIGS. 4, 4-1, 4-2, 4-3, and 4-4 may be similar to and/or may differ from the structures 101, 101-1, 101-2, 101-3, 101-4, 201, 301, 301-1, 301-2 of the previous Figures. Like numbers indicate like elements. For example, similar to FIG. 1-1, for the portion of the structure 401 at 4-1, peripheral edges 413, 423, 433 may be coterminous. In another example, unlike FIG. 1-1, the structure 401 is shown with three layers 410, 420, 430 instead of the two layers 110, 120 shown in FIG. 1-1.

For ease of description, the first, second, and third layers 410, 420, 430 may include outermost layers 411, 421, 431, innermost layers 412, 422, 432, one or more peripheral edges 413, 423, 433, thicknesses 418, 428, 438, maximum thicknesses 419, 429, 439, or combinations thereof, respectively. The first layer 410, the second layer 420, and the third layer 430 may form a combined layer 490. The combined layer 490 may include a combined thickness 498. The thickness 498 may be measured from the innermost surface 492 of the combined layer 490 to the outermost surface 491 of the combined layer 490. The combined layer 490 may include a maximum thickness (not shown) as described herein.

FIG. 4-2 is a partial cross-sectional side view at 4-2 of the embodiment of the structure 401 of FIG. 4 about line 4-2 at a single peripheral edge 493 of a combined layer 490. The illustrated portion of the structure 401 at 4-2 may be similar to a portion of the peripheral edge 193-4 shown in FIG. 1-1-4. For example, the third layer 430 may be located between the first layer 410 and the second layer 420, similar to the input sensor 180-4 in FIG. 1-1-4. The illustrated portion of the structure 401 at 4-2 may be similar to a portion of the peripheral edge 193 shown in FIG. 1-1. For example, the peripheral edges 413, 423, 433 of the first, second, and third layers 410, 420, 430 may be coterminous like the peripheral edges 113, 123 of the first and second layers 110, 210 in FIG. 1-1.

FIG. 4-3 is a partial cross-sectional side view at 4-3 of the embodiment of the structure 401 of FIG. 4 about line 4-3 at a peripheral edge 493 of a combined layer 490 and through a connector 408. The connector 408 may be used to connect the structure 401 to another structure (e.g., structure 301 of the monitor 307 in FIG. 3), as described above.

The connector 408 may be at least partially located between the first layer 410 and the second layer 420. As shown, the connector 408 at least partially abuts the first layer 410 and the third layer 430. In another embodiment, the connector 408 may abut the second layer 420 and the third layer 430. Other permutations of the first, second, and third layers 410, 420, 430 and the connector 408 are contemplated. As shown the connector 408 and the third layer 430 are coterminous at a peripheral edge (e.g., the right peripheral edge 433). In other embodiments, the connector 408 may extend beyond the third layer or vice versa.

FIG. 4-4 is a partial cross-sectional side view at 4-4 of the embodiment of the structure 401 of FIG. 4 about line 4-4 at a peripheral edge 493 of a combined layer 490 and through an electrical connector 409. The electrical connector 409 may be at least partially located between the first layer 410 and the second layer 420. As shown, the electrical connector 409 at least partially abuts the first layer 410 and the second layer 420. As shown in FIG. 4-4, the portion of the connector at 4-4 does not include the third layer 430. Thus, the third layer 430 may extend around less than the entire peripheral edge 493 of the combined layer 490. In other embodiments, the third layer 430 may extend around the entire peripheral edge 493. For example, the electrical connector 409 may be located between the third layer 430 and the first or second layers 410, 420.

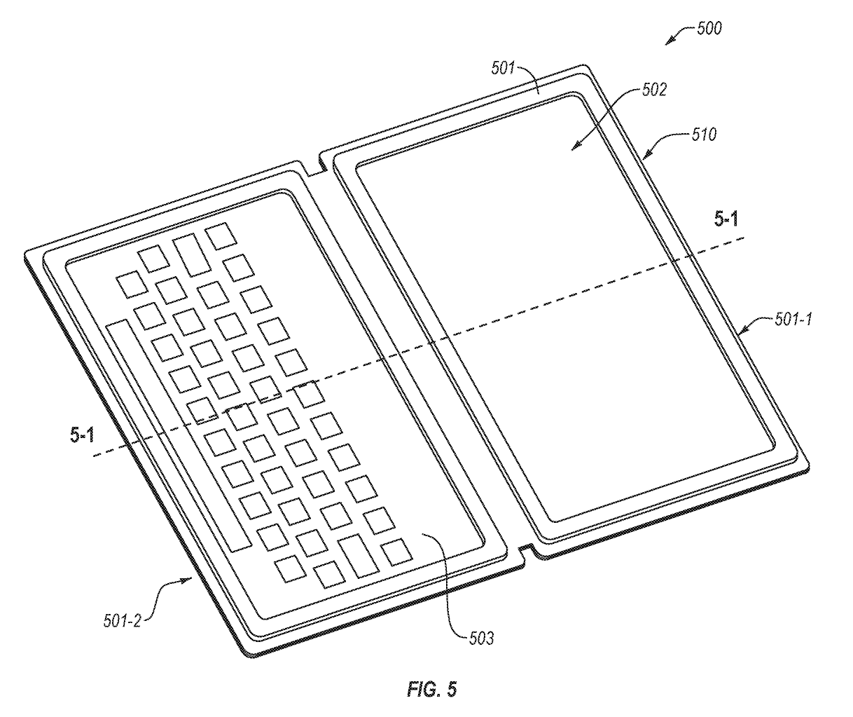

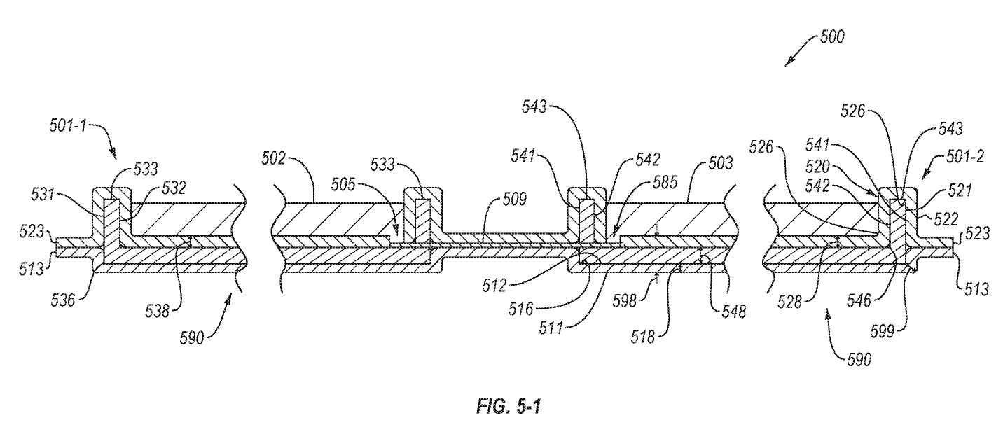

FIG. 5 is a perspective view of an embodiment of a computing device 500 that includes a structure with two portions 501-1, 501-2 for housing electronic components. One or more elements of one or more of the structures 101, 101-1, 101-2, 101-3, 101-4, 201, 301, 301-1, 301-2, 401 may be incorporated into one or more structure portions 501-1, 501-2 of the computing device 500 of FIGS. 5 and 5-1 and vice versa.

The first portion 501-1 may include a display 502. The display 502 may be may display information (e.g., in a standard monitor) and/or act as an input (e.g., a touch screen monitor). The second portion 501-2 may include an input 503. The input 503 may be a keyboard. In other embodiments, the input 503 may also display information. For example, the input 503 may include a touch screen monitor. In some embodiments, the first portion 501-1 may include a display 502 and an input as a touch screen monitor and the second portion 501-2 may include an input 503 and a display as a touch screen monitor.

The first portion 501-1 and the second portion 501-2 may be connected. For example, an electrical connector 509 may connect the first and second portions 501-1, 501-2. As described above, an electrical connector 509 may include a flexible printed circuit, a display port, one or more wires, other electrical connectors, or combinations thereof.

Although the computing device 500 is illustrated in a flat configuration, the computing device 500 may be moved from a flat configuration to a working configuration (e.g., where the user can see the display 502 and use the input 503) and/or to a closed configuration where the display 502 and the input 503 may be directly adjacent. For example, the computing device 500 may include a connector 508, such as a hinge that may keep the display 502 in the working configuration. In another example, a kickstand may be connected to the structure to keep the display 502 in the working configuration.

Referring to FIG. 5-1, a side cross-sectional view along line 5-1 in FIG. 5 of the embodiment of a computing device 500 in FIG. 5. FIG. 5-1 illustrates multiple layers of materials. As shown, the first layer 510 and the second layer 520 may be fabric layers. The first layer 510 and the second layer 520 may encapsulate a third layer 530 in the first portion 501-1 of the structure. The first layer 510 and the second layer 520 may encapsulate a fourth layer 540 in the second portion 501-2 of the structure.

The first, second, third, and fourth layers 510, 520, 530, 540 may include outermost surfaces 511, 521, 531, 541, innermost surfaces 512, 522, 532, 542, peripheral edges 513, 523, 533, 543, and/or edges 516, respectively. The first layer 510 and the second layer 520 may be at least partially affixed together. For example, at least a portion of an innermost surface 512 of the first layer 510 may be affixed to at least a portion of an outermost surface 521 of the second layer 220 in the first portion 501-1 and/or the second portion 501-2 of the structure.

The first layer 510 and/or the second layer 520 may be at least partially affixed to at least a portion of the third layer 530 in the first portion 501-1 of the structure. The first layer 510 and/or the second layer 520 may be at least partially affixed to at least a portion of the fourth layer 540 in the second portion 501-2 of the structure. The first layer 510 and/or the second layer 520 may be at least partially affixed to at least a portion of the electrical connector 509. The display 502 and/or the input 503 may be affixed to at least a portion of the second layer 520. For example, the display 502 and/or the input 503 may be affixed to the innermost surface 522 of the second layer 520. In another example, an aperture may be formed through at least a portion of the second layer 520 such that the display 502 and/or the input 503 may be affixed to the third layer 530 and/or the fourth layer 540.

One or more apertures 505 may be formed in one or more layers of one or more of the portions 501-1, 501-2 of the structure. For example, an aperture 505 may be formed through the second layer 520 and the third layer 530 in the first portion 501-1 of the structure. In another example, an aperture 505 may be formed through the second layer 520 and the fourth layer 540 in the second portion 501-2 of the structure. At least a portion of the electrical connector 509 may be inserted through one or more apertures 505. For example, the electrical connector 509 may be in electronic communication with the display 502 and/or input 503 by connecting to the display 502 and/or input 503 through one or more apertures.

A combined layer 590 may be formed by one or more of the first, second, third, fourth layers 510, 520, 530, 540 and/or the electrical connector 509. For example, where only the first and second layers 510, 520 abut, at least a portion of the combined layer 590 may be formed between these layers. In another example, the first, second, and third layers 510, 520, 530 may form at least a portion of the combined layer 590. In a further example, the first, second, and fourth layers 510, 520, 540 may form at least a portion of the combined layer 590.

The first, second, third, and fourth layers 510, 520, 530, 540 may include thicknesses 518, 528, 538, 548 that may include maximum thicknesses (not shown). The combined layer 590 may also include one or more thicknesses 598 as described herein.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A structure for housing electronic components, comprising:
a first layer having a modulus of elasticity of less than 2.41 MPa;
a second layer having a modulus of elasticity of less than 2.41 MPa; and
the second layer affixed to the first layer to form a combined layer, the combined layer having combined modulus of elasticity of less than 2300 MPa.

2. The structure of claim 1, wherein the first layer has a first thickness at a first point and the second layer has a second thickness at the first point, the first thickness and the second thickness defining a combined thickness of the combined layer at the first point of less than 1.5 mm.

3. The structure of claim 1, wherein the first layer has a first density and the second layer has a second density, the first density and the second density defining a composite density of the combined layer that is less than 1740 kg/m³.

4. The structure of claim 1, wherein the first layer is an outermost layer.

5. The structure of claim 4, wherein the outermost layer is leather.

6. The structure of claim 4, wherein the outermost layer is non-woven or woven textile.

7. The structure of claim 6, wherein a material of the textile is selected from the group consisting of polyurethane, polyester, and nylon.

8. The structure of claim 6, wherein a material of the textile excludes glass fiber.

9. The structure of claim 1, further comprising a third layer between the first layer and the second layer.

10. The structure of claim 9, wherein the third layer is foam.

11. A structure for housing electronic components, comprising:
an innermost textile layer;
an outermost textile layer;
the innermost layer bonded to the outermost layer to form a combined layer; and
the combined layer being transparent to electromagnetic waves having a frequency between 600 MHz and 6 GHz or not being electrically conductive across an entire surface area of the combined layer.

12. The structure of claim 11, wherein a modulus of elasticity of the innermost textile layer and a modulus of elasticity of the outermost textile layer define a combined modulus of elasticity of the combined layer that is greater than 25 GPa.

13. The structure of claim 11, wherein the outermost textile layer has a first thickness at a first point and the innermost textile layer has a second thickness at the first point, the first thickness and the second thickness defining a combined thickness of the combined layer at the first point of less than 1.5 mm.

14. The structure of claim 11, wherein the outermost textile layer has a first density and the innermost textile layer has a second density, the first density and the second density defining a composite density of the combined layer that is less than 1740 kg/m³.

15. A structure for housing electronic components, comprising:
a first layer having a modulus of less than 2.41 MPa;
a second layer having a modulus of less than 2.41 MPa; and
the second layer affixed to the first layer to form a combined layer, the combined layer being polycarbonate free.

16. The structure of claim 15, wherein the modulus of elasticity of the first layer and the modulus of elasticity of the second layer define a combined modulus of elasticity that is greater than 25 GPa.

17. The structure of claim 15, wherein the structure includes an input.

18. The structure of claim 17, wherein the input is a keyboard.

19. The structure of claim 15, wherein the structure includes a display.

20. A computing device, comprising:
the structure of claim 18; and
the structure of claim 19.

21. The structure of claim 15, further comprising a third layer.

22. The structure of claim 21, wherein the modulus of elasticity of the third layer is less than 2.41 MPa.

23. The structure of claim 21, wherein the modulus of elasticity of the third layer is greater than modulus of elasticity of both the first layer and the second layer.

24. The structure of claim 21, wherein the third layer is an electrical connector.

25. The structure of claim 17, wherein the structure includes a first portion and a second portion.

26. The structure of claim 25, wherein the first portion includes a display and the second portion includes the input.

27. The structure of claim 26, wherein the first portion and the second portion are connected by an electrical connector.

28. The structure of claim 27, wherein the display and the input are in electrical communication through the electrical connector.

29. The structure of claim 27, wherein the electrical connector is a flexible printed circuit.

30. The structure of claim 27, wherein the first surface and the second surface abut the electrical connector.
